(19) United States
(12) Patent Application Publication
(10) Pub. No.: US 2023/0383588 A1
(43) Pub. Date: Nov. 30, 2023

(54) MULLION SYSTEMS AND METHODS FOR THE SAME

(71) Applicant: Marvin Lumber and Cedar Company, LLC d/b/a Marvin Windows and Doors, Eagan, MN (US)

(72) Inventor: David M. Lund, Detroit Lakes, MN (US)

(21) Appl. No.: 18/201,522

(22) Filed: May 24, 2023

Related U.S. Application Data
(60) Provisional application No. 63/365,246, filed on May 24, 2022.

(51) Int. Cl. E06B 1/60

(52) U.S. Cl. CPC E06B 1/6007

(57) ABSTRACT

A mullion assembly includes at least one mullion pin configured to clamp proximate fenestration frame members together. The at least one mullion pin includes a pin body configured for movable coupling between the proximate fenestration frame members. First and second anchor cleats extend from the pin body. The at least one mullion pin is movable from an introduced configuration to a locked configuration. In the locked configuration the first and second anchor cleats are configured to clamp the fenestration frame members together.

### COPYRIGHT NOTICE

A portion of the disclosure of this patent document contains material that is subject to copyright protection. The copyright owner has no objection to the facsimile reproduction by anyone of the patent document or the patent disclosure, as it appears in the Patent and Trademark Office patent files or records, but otherwise reserves all copyright rights whatsoever. The following notice applies to the software and data as described below and in the drawings that form a part of this document: Copyright Marvin Lumber and Cedar Company, LLC d/b/a Marvin Windows and Doors, of Eagan, Minnesota, USA. All Rights Reserved.

### CLAIM OF PRIORITY

This patent application claims the benefit of priority to U.S. Provisional Application Ser. No. 63/365,246, filed May 24, 2022, which is incorporated by reference herein in its entirety.

### TECHNICAL FIELD

This document pertains generally, but not by way of limitation, to fenestration assemblies and mullions for fenestration assemblies.

### BACKGROUND

Fenestration assemblies in some examples include multiple component fenestration assemblies that are interconnected with mullions. The mullion couples the component fenestration assemblies together to facilitate alignment of the component fenestration assemblies.

In some examples, mullions are installed with component windows at a job site or factory. For instance, the component fenestration assemblies are arranged and aligned relative to each other, for instance on assembly tables, sawhorses or the like. The assembly tables permit adjustment of the component fenestration assemblies by installers (e.g., moving the assemblies relative to each other on a table) to ensure alignment of interconnecting features of the component fenestration assemblies and adjust the assemblies if a misalignment is observed. Additionally, arrangement of the component fenestration assemblies on assembly tables, sawhorses or the like provides access to interconnecting features of the fenestration assemblies by the mullions.

Once the component fenestration assemblies are assembled into the mulled fenestration assembly the resulting assembly is shipped to a job site, and raised, for instance with a hoist, mechanical lift, multiple installers or the like, to a rough opening. The mulled fenestration assembly is inserted into the rough opening and fixed to the surrounding frame of the building.

### SUMMARY

The present inventor has recognized, among other things, that a problem to be solved can include facilitating mulling (installation of mullion assemblies) component fenestration assemblies in a variety of conditions. In some examples component fenestration assemblies are arranged and aligned prior to installation to assemble a composite fenestration assembly. For instance, the component fenestration assemblies are arranged at a manufacturing facility, supplier or at a job site. Arrangement includes laying the fenestration assemblies adjacent to each other and installing mullion assemblies therebetween. In various examples, installation of mullion assemblies includes, but is not limited to, installation of brackets, lineal adapters or the like that are fastened to adjoining frame components of the component fenestration assemblies to make the assemblies ready for mulling. Because the fenestration assemblies are not yet installed manipulation and movement of the assemblies as well as access to gaps between the assemblies is facilitated to assist with installation of mullion components (e.g., brackets, lineal adapters or the like) and coupling of the fenestration assemblies together with the mullion assemblies.

In some examples, the mullion assembly includes one or more difficult to install connection brackets or lineal connection pieces that are inserted into complementary lineal kerfs, recesses or the like (e.g., provided by brackets, lineal adapters or the like) provided along adjoining fenestration frames of the fenestration assemblies. Because the fenestration assembly is not installed, access is available to the brackets and the fenestration frames. A rubber mallet, hammer or the like is used by a technician to drive the bracket into the complementary kerfs. The brackets, like nails or other fasteners, are subject to deformation and breakage when struck during installation. Additionally, the component fenestration assemblies and the associated kerfs or features that couple with the brackets need precise alignment for reception of the brackets. In some examples, the technician has to pull the bracket and start again with an undamaged bracket. This can be a labor intensive and time consuming process.

Additionally, once the component fenestration assemblies are interconnected with the mullion assembly the resulting composite fenestration assembly is cumbersome to install in a rough opening. The component fenestration assemblies, in some examples, weigh hundreds of pounds and have large or awkward profiles, and the composite assembly is equivalent to multiples of that weight and additionally cumbersome because of the increased size. The composite fenestration assembly is raised into place with multiple technicians or with a lift (e.g., forklift, hoist, crane or the like). The technicians then attempt to provide fine manipulation of the composite fenestration assembly to position the assembly within the rough opening and adjust installation characteristics (e.g., square, true, level, plumb or the like). The weight and awkwardness frustrate this fine manipulation.

The present subject matter can help provide a solution to these problems with a mullion system that is readily installed to component fenestration assemblies while the fenestration assemblies are already positioned in a rough opening. Alternatively, the mullion system is installed to component fenestration assemblies during assembly of a composite fenestration assembly, for instance outside of the rough opening.

The mullion system includes a mullion pin (or rail if a lineal configuration). The mullion pin includes anchor cleats configured to connect the mullion pin with complementary cleat recesses of the fenestration assemblies. For instance, the fenestration frames include cleat recesses. With the fenestration assemblies positioned within a rough opening (e.g., without shimming, fastening or the like) the mullion pin (or pins) is inserted into the gap between the frames. In the introduced configuration the technician drives the mullion pin with one or more of hand pressure, a mallet or the like, for instance from exterior toward interior or interior toward exterior. The anchor cleats are correspondingly moved along the fenestration frames. The mullion pin and the anchor cleats have a complementary profile to the fenestration frame and the cleat recesses. Continued movement of the mullion pin moves the anchor cleats toward and over the cleat recesses, and the anchor cleats descend into the cleat recesses.

One or both of the anchor cleats or the cleat recesses have a clamping surface. For instance, the clamping surface has a tapered configuration (e.g., cammed, wedged configurations or the like) that cooperates with an opposed surface of either or both of the cleat recesses or the anchor cleats. The anchor cleats and cleat recesses cooperate to lock the component fenestration assemblies together at the mullion assembly. In one example, after reception of the anchor cleats within the cleat recesses continued movement of the mullion pin drives the clamping surface along the (opposed) clamping surface and biases the component fenestration assemblies (e.g., their associated fenestration frames) together. Optionally, a locking bracket, such as a cap, cover, bracket, fastener or the like is coupled between the fenestration frames, coupled with the mullion pin or both to secure the mullion pin and the anchor cleats in place and retain the fenestration assemblies and the mullion pin in the locked configuration.

This overview is intended to provide an overview of subject matter of the present patent application. It is not intended to provide an exclusive or exhaustive explanation of the invention. The detailed description is included to provide further information about the present patent application.

### BRIEF DESCRIPTION OF THE DRAWINGS

In the drawings, which are not necessarily drawn to scale, like numerals may describe similar components in different views. Like numerals having different letter suffixes may represent different instances of similar components. The drawings illustrate generally, by way of example, but not by way of limitation, various embodiments discussed in the present document.

FIG. 1 is a perspective view of one example of a composite fenestration assembly including a mullion assembly.

FIG. 2 is a detailed perspective view of one example of a mullion assembly in a locked configuration.

FIG. 3 is an exploded view of the mullion assembly of FIG. 2.

FIG. 4A is a cross sectional view of the mullion assembly of FIG. 2 in the locked configuration.

FIG. 4B is another cross sectional view of the mullion assembly of FIG. 2 in the locked configuration.

FIG. 5 is an exploded view of the mullion assembly of FIG. 2 including fenestration frame members.

FIG. 6A is a cross sectional view showing a mullion pin of the mullion assembly of FIG. 2 in an introduced configuration.

FIG. 6B is a cross sectional view showing the mullion pin of FIG. 6A in an intermediate configuration between the introduced and locked configurations.

FIG. 7 is a cross sectional view of another example of a mullion assembly.

FIG. 8 is a cross sectional view of an additional example of a mullion assembly configured to adapt fenestration assemblies to varied frame profiles.

FIG. 9 is a cross sectional view of a supplemental example of a mullion assembly.

FIG. 10A is a cross sectional view of the mullion assembly of FIG. 9 in an introduced configuration.

FIG. 10B is a cross sectional view of the mullion assembly of FIG. 9 in a locked configuration.

FIG. 11 is a cross sectional view of the mullion assembly of FIG. 9 in another locked configuration with the mullion assembly reversed.

FIG. 12 is an exploded view of still another example of a mullion assembly.

FIG. 13A is a cross sectional view of the mullion assembly of FIG. 12 in an introduced configuration.

FIG. 13B is a cross sectional view of the mullion assembly of FIG. 12 in a locked configuration.

FIG. 14 is a block diagram of one example of a method for mulling fenestration assemblies.

### DETAILED DESCRIPTION

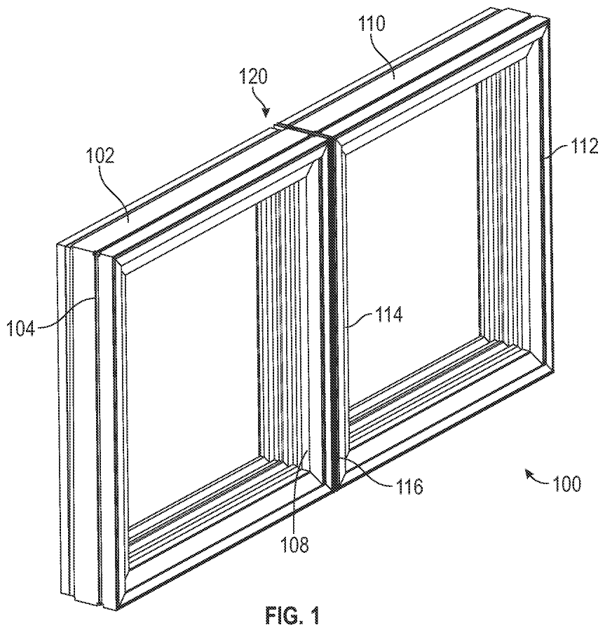

FIG. 1 is a perspective view of an example composite fenestration assembly 100 including a plurality of component fenestration assemblies. In the example shown the composite fenestration assembly 100 includes a first fenestration assembly 102 and a second fenestration assembly 110. The fenestration assemblies 102, 110 include one or more of door assemblies, window assemblies or the like. Each of the fenestration assemblies 102, 110 include respective first and second fenestration frames 104, 112. In an example, the fenestration assemblies 102, 110 include panels, such as first and second panels 105, 113. In some examples, the panels 105, 113 are sashes or door panels and are optionally movably coupled with the fenestration frames 104, 112, for instance as single hung, double hung, casement, awning windows or the like.

Referring again to FIG. 1, the first and second fenestration frames 104, 112 include respective first and second fenestration members 108, 114. As shown in FIG. 1, these first and second fenestration members 108, 114 are proximate to each other. An example fenestration gap 116 is provided therebetween.

A mullion assembly 120 interconnects the component first and second fenestration assemblies 102, 110 of the composite fenestration assembly 100. As described herein, the mullion assembly 120 permits the interconnection of multiple fenestration assemblies (such as 102, 110). The mullion assembly examples described herein (including 120) provide an affirmative and robust coupling to permit handling and installation of the composite fenestration assembly 100 while at the same time maintaining an alignment of the component fenestration assemblies 102, 110. Further, the affirmative and robust coupling permits the collective adjustment of the composite fenestration assembly 100 including one or more of plumbing, trueing, leveling and squaring.

Further still, the mullion assemblies permit the coupling of separate fenestration assemblies 102, 110 while the assemblies are already partially installed, for instance, within a rough opening. As discussed herein, the mullion assemblies are optionally installed through the fenestration gap 116 and anchor cleats are coupled with complementary features of the fenestration assemblies 102, 110, such as cleat recesses. The mullion assemblies are adjusted, for instance with fasteners, brackets or the like (optional components of the mullion assemblies) to seat the anchor cleats within cleat recesses, affirmatively engage the anchor cleats with the fenestration assemblies 102, 110, and also contract the fenestration gap 116 and accordingly pull the assemblies into intimate and robust coupling with each other. The coupling of the mullion assemblies with the fenestration assemblies 102, 110, engagement between the mullion assemblies and fenestration assemblies, and contraction of the fenestration gap 116 is optionally conducted within the fenestration gap 116, for instance from the interior or exterior sides of the fenestration assemblies 102, 110. Accordingly, separate handling of the fenestration assemblies, spreading apart of the assemblies, and access to upper and lower portions of the fenestration assemblies for driving of interconnecting adapters, lineal brackets or the like into lineal kerfs extending between the upper and lower portions of the assemblies.

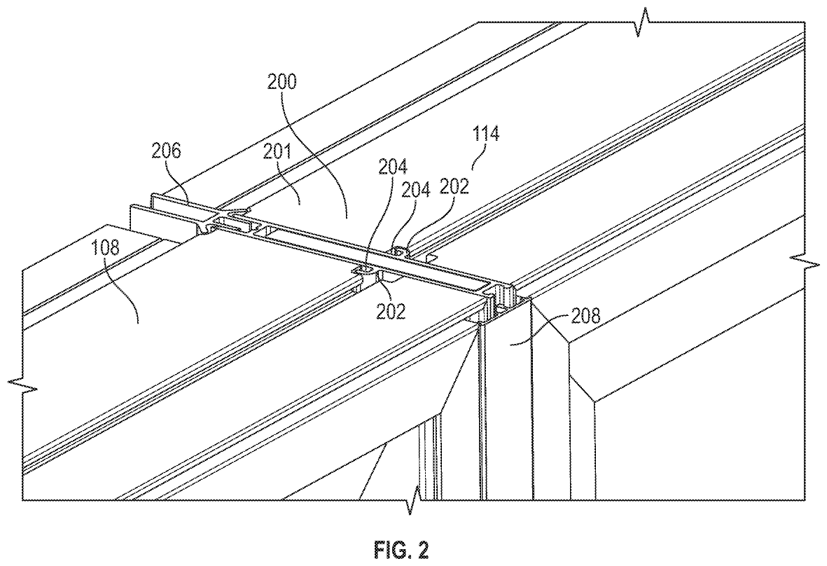

FIG. 2 is a perspective cross sectional view showing one example of a mullion assembly 201 coupling together first and second fenestration frame members 108, 114 (e.g., of the fenestration frames 104, 112 in FIG. 1). The mullion assembly 201 is shown in a locked configuration that affirmatively and robustly interconnects the first and second fenestration assemblies 102, 110 together.

As shown, the mullion assembly 201 includes a mullion pin 200 between the first and second fenestration frame members 108, 114. As described herein, the mullion pin 200 is in one example inserted between the members, for instance from one of the exterior or interior sides of the fenestration frames 104, 112 and moved toward the opposed side to interfit anchor cleats 202 with cleat recesses 204. Examples of the anchor cleats 202 are shown in FIG. 2, and extend from the mullion pin 200. The first and second fenestration frame members 108, 114 include complementary cleat recesses 204. In an example, the anchor cleats 202 extend continuously along the mullion pin, and accordingly fit into corresponding continuous cleat recesses 204 extending along the frame members 108, 114. In other examples, the anchor cleats 202 are discontinuous, and are for instance provided along the length of the mullion pin 200 (e.g., extending upward and downward from the section) at spaced locations.

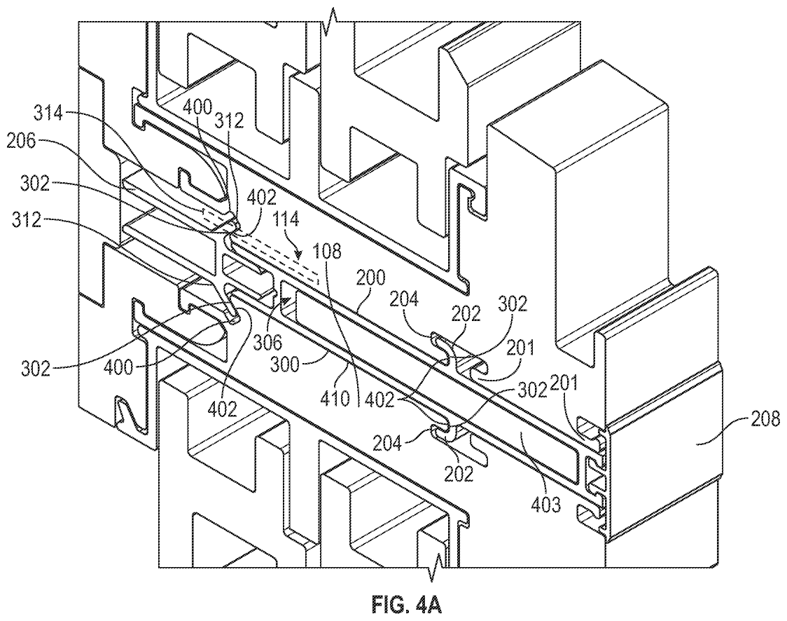

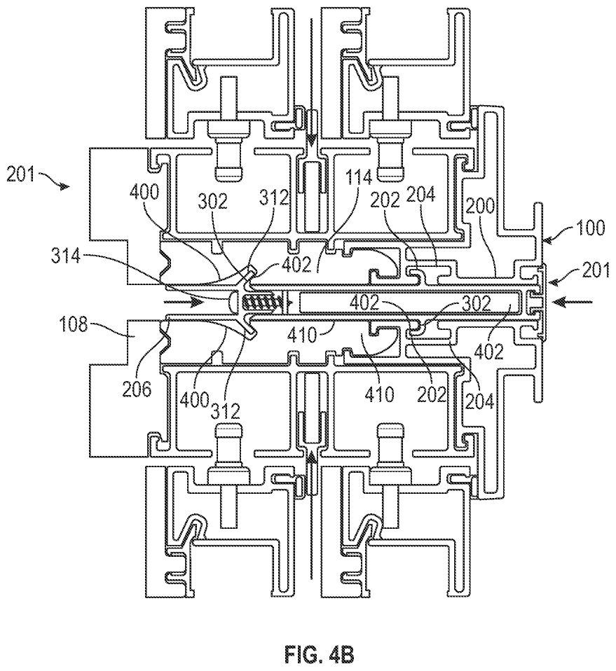

As further shown in FIG. 2, the mullion assembly 201 includes in an example a locking bracket 206. The locking bracket 206 in an example is inserted from one of the interior or exterior sides of the fenestration frame members 108, 114 and coupled with the mullion pin 200. The locking bracket 206, in an example, extends along the frame members 108, 114 in a similar manner to the mullion pin 200 (e.g., toward the top and bottom of the page in FIG. 2). Optionally, the locking bracket 206 includes its own anchor cleats and the frame members 108, 114 include complementary cleat recesses (shown in more detail in FIGS. 4A, B). The locking bracket 206 cooperates with the mullion pin 200, for instance with an interconnecting fastener, to bias the anchor cleats 202 of the mullion pin 200 (and optionally the bracket 206) into the cleat recesses 204. As described herein, the engagement of clamping surfaces 302 of the anchor cleats 202 and the cleat recesses 204 affirmatively couples the first and second fenestration frame members 108, 114 together. Additionally, and also described herein, the engagement between the anchor cleats 202 and the cleat recesses 204, such as their complementary clamping surfaces, draws the fenestration frame members 108, 114 together and accordingly contracts or compresses the fenestration gap 116 between the members. The contraction affirmatively engages the frame members 108, 114 and the associated fenestration assemblies 102, 110 (see FIG. 1) together and provides a robust coupling therebetween.

Referring again to FIG. 2, in another example the mullion assembly 201 includes a mullion cover 208. The mullion cover 208 is coupled with one or more of the fenestration frame members 108, 114 or the remainder of the mullion assembly 201, such as the mullion pin 200. The mullion cover 208 provides a contoured surface that bridges across the fenestration assemblies 102, 110 and provides the appearance of a continuous and unitary composite fenestration assembly 100. In another example, the mullion cover 2008 includes its own anchor cleats or the like configured for seating within cleat recesses and engagement of clamping surfaces to interconnect the first and second fenestration frame members 108, 114.

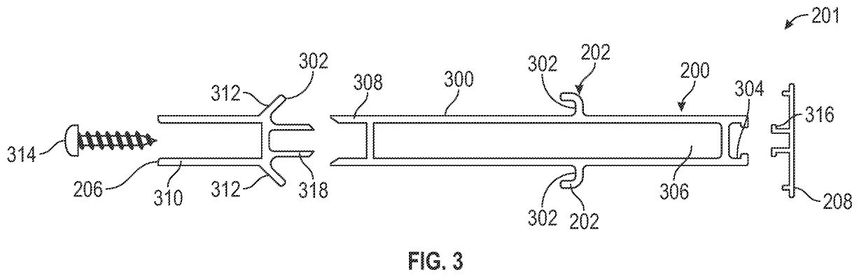

FIG. 3 is an exploded view of the mullion assembly 201. The mullion pin 200 is decoupled from the locking bracket 206, and the mullion cover 208 is decoupled from the mullion pin 200. The mullion pin 200, locking bracket 206 and the mullion cover extending into and out of the page, for example in a lineal manner corresponding to the lengths of the associated fenestration frame members (e.g., 108, 114 in FIGS. 1 and 2).

The mullion pin 200 in this example includes first and second anchor cleats 202. The cleats 202 have an angled orientation in this example to permit cooperative engagement with cleat recesses of the frame members. For instance, each of the anchor cleats 202 includes a clamping surface 302 that provides an angled orientation (e.g., tapered, curved, hooked, angled relative to the interior to exterior axis of the pin body 300 or the like). As described herein, the clamping surface 302 cooperatively engage with and bias the fenestration assemblies to robustly interfit with the mullion assembly 201. The bias caused by the mullion assembly 201 draws the frame members 108, 114 together (and closes the fenestration gap).

The mullion pin 200 includes a pin body 300, and the anchor cleats 202 extend from the pin body 300 (e.g., at the angled orientation). In one example, the pin body 300 includes a pin cavity 306. In one example, the mullion pin 200 receives a mullion brace (403 in FIG. 4B) within the pin cavity 306. The mullion brace supports the mullion pin 200 and minimizes deflection or deformation, for instance caused by loading from the proximate fenestration assemblies. Additionally, the mullion brace enhances the engagement between the proximate fenestration frame members 108, 114 and provides an affirmative coupling therebetween that secures the component fenestration assemblies 102, 110 and intervening mullion assembly 201 as a unitary composite assembly (e.g., 100, with minimal movement, deflection, deformation or the like between the component assemblies). Stated another way, the composite fenestration assembly 100 is a robust structure with constrained deflection or deformation at the mullion assembly 201. Instead, the composite fenestration assembly 100 is installed, operated and maintained as a unitary component.

Referring again to FIG. 3, the locking bracket 206 is shown exploded relative to the mullion pin 200. In this example, the locking bracket 206 includes anchor cleats 312 extending from a bracket body 310. The anchor cleats 312, in a similar manner to the anchor cleats 202, include clamping surfaces 302 having angled orientations (e.g., tapered, curved hooked, angled relative to the interior to exterior axis of the bracket body 310 or the like) to cooperatively interfit with the clamping surfaces of cleat recesses of fenestration frame members.

In another example, the locking bracket 206 includes a bracket plug 318 proximate to the mullion pin 200. The mullion pin 200 includes a pin socket 308. The pin socket 308 and bracket plug 318 couple the mullion assembly 201 together and decrease rotational or pivoting movement therebetween. Further, the interfitting of the bracket plug 318 and the pin socket 308 guide relative movement between the mullion pin 200 and the locking bracket 206 and accordingly guides interfitting of the associated anchor cleats 202, 312 with the respective cleat recesses provided with the fenestration frame members 108, 114.

A fastener 314 is further shown in FIG. 3. The fastener 314 optionally includes a graduated interface, such as threading. The fastener 314 is coupled between the locking bracket 206 and the mullion pin 200 in an example. Movement of the fastener 314 moves the locking bracket 206 relative to the mullion pin 200. As described herein, the movement of the locking bracket 206 relative to the mullion pin 200 cooperatively moves the anchor cleats 202, 312 relative to the cleat recesses of the fenestration frame members, affirmatively seats the cleats therein, clamps the fenestration frame members to the mullion assembly 201, and biases the fenestration frame members toward each other to affirmatively engage with the mullion assembly 201.

Referring again to FIG. 3, the mullion cover 208 is shown decoupled from the mullion pin 200. As shown the mullion cover 208 includes a cover fitting 316. The mullion pin 200 includes a pin fitting 304 complementary to the cover fitting 316. In one example, the pin fitting 304 and the cover fitting 316 cooperatively fit to couple the mullion cover 208 with the remainder of the mullion assembly 201, such as the mullion pin 201. In another example, the mullion cover 208 includes one or more features, such as anchor cleats. In this example, coupling of the mullion cover 208 with the mullion pin (e.g., with the cover fitting 316) positions anchor cleats for the mullion cover 208 within corresponding cleat recesses of the fenestration frame members proximate to the mullion cover 208. The mullion cover 208, in this example, accordingly provides another feature of the mullion assembly 201 that robustly couples the fenestration assemblies together.

FIGS. 4A and 4B illustrate perspective sectional and sectional views of the mullion assembly 201 in the locked configuration with first and second fenestration frame members 108, 114. Each of the mullion pin 200 and the locking bracket 206 are interposed between the first and second fenestration members 108, 114. The locking bracket 206 is coupled with the mullion pin 200, and the anchor cleats 202, 312 of the mullion pin 200 and the locking bracket 206, respectively, are positioned within the cleat recesses 204.

In one example, the fastener 314 couples the locking bracket 206 with the mullion pin 200. Movement of the fastener 314 moves the bracket 206 and mullion pin 200 relative to each other (in this example toward each other) and drives the anchor cleats 202, 312 into the associated cleat recesses 204. The cooperative coupling of the anchor cleats 202, 312 with the respective cleat recesses 204, 400 affirmatively couples the mullion assembly 201 with the fenestration frame members 108, 114 and accordingly affirmatively locks the members together. For instance, the anchor cleats 202, 312 seated with cleat recesses 204, 400 capture corresponding portions of the fenestration members 108, 114 between the anchor cleats.

In another example, the clamping surfaces 302, 402 shown in FIGS. 4A and 4B for each of the anchor cleats 202, 312 and cleat recesses 204, 400 cooperatively engage and move relative to each other, for instance with relatively movement of the locking bracket 206 and the mullion pin 200. The clamping surfaces 302, 402 have angled orientations that bias the anchor cleats 202, 312 into affirmative interfitting and draw the fenestration assemblies (e.g., the frame members 108, 114) into proximity with each other. For instance, the frame members 108, 114 are pulled into intimate engagement along one or more of the mullion pin 200, the locking bracket 206 or both of the mullion assembly 201. As shown in FIG. 4B with horizontal arrows, as the locking bracket 202 is moved toward the mullion pin 200 (e.g., with the fastener 314) the anchor cleats 202, 312 slide along the clamping surfaces of the 402 of the cleat recesses 204, 400 and thereby pull the fenestration frame members 108 toward each other (vertical arrows directed toward the mullion assembly 201) and into engagement with the mullion assembly 201. This lateral movement of the fenestration members 108, 114 contracts the fenestration gap 410 between the members 108, 114 at least until the mullion assembly 201 pulls the members into contact with the assembly 201. Additionally, the anchor cleats 202, 312 are affirmatively seated within the cleat recesses 204, 400 ensuring the fenestration assemblies 102, 110 are affirmatively and robustly coupled. Although the mullion assembly 201 is loaded in tension in this example (e.g., one or more of the mullion pin 200 or the locking bracket 202) in other examples provided herein the mullion assemblies are loaded in compression in or are not loaded (e.g., are not affirmatively tensioned or compressed). The anchor cleats and associated cleat recesses are oriented to cooperatively and affirmatively engage with the fenestration frame members with one or more of compression or tension of the respective mullion assemblies or without loading.

As discussed herein, movement of the mullion pin 200 seats the anchor cleats 202, 312 within the cleat recesses 204, 400, and continued movement clamps the fenestration frame members 108, 114 together (e.g., draws them closer, contracts the fenestration gap and affirmatively pulls them into engagement with the mullion pin or the like). In an example, the clamping of the fenestration frame members 108, 114 with the mullion assembly 201 contracts the fenestration gap 410 therebetween as the members are affirmatively engaged with the mullion assembly 201. In some examples, the clamping of the fenestration frame members 108, 114 together moves the fenestration assemblies 102, 110 into a square orientation and conversely minimizes out of square orientation of the assemblies. For instance, the associated fenestration frame members 108, 114 are aligned with each other, and accordingly the remainder of the fenestration assemblies 102, 110 are similarly aligned.

Referring again to FIGS. 4A and 4B an optional mullion brace 403 is coupled with the mullion assembly 201. For example, the mullion brace 403 is positioned within the mullion pin 200, such as a pin cavity 306 of the pin 200. The mullion brace 403 includes, but is not limited to, structurally robust materials such as wood, metal, composites (e.g., polymers, fiberglass) or the like that brace the mullion assembly 201 and enhance the strength of the connection between the component fenestration assemblies 102, 110 (e.g., the frame members 108, 114). The robust coupling provided by the mullion assembly 201 (with or without the mullion brace 403) minimizes deflection of the composite fenestration assembly 100 at the mullion assembly 201. Accordingly, deflection and deformation caused during handling, pressure differentials during inclement weather or the like are decreased with the composite fenestration assembly 100 having the mullion assembly 201.

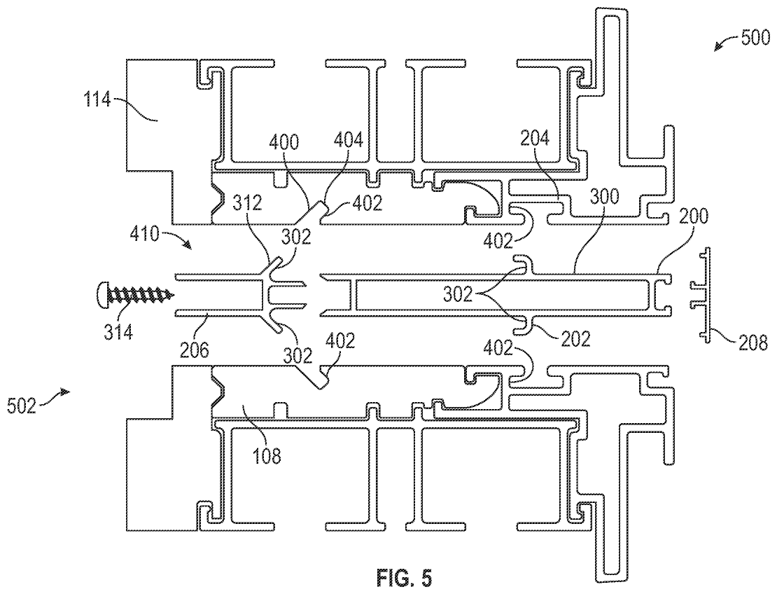

FIG. 5 is an exploded view of the mullion assembly 201 and the fenestration frame members 108, 114 illustrating the anchor cleats 202, 312 and cleat recesses 204, 400. Additionally, FIG. 5 illustrates the clamping surfaces 302 associated with each of the anchor cleats 202, 312. As shown, the clamping surfaces 302 have an angled orientation. FIG. 5 also shows the angled orientation of the clamping surfaces 402 of the cleat recesses 204, 400. The clamping surfaces 402, 302 cooperatively interfit with each other upon installation of the mullion assembly 201 with the fenestration frame members 108, 114. As shown in FIGS. 4A and 4B, the anchor cleats 202, 312 seat within the cleat recesses 204, 400. Movement of the mullion assembly 201 within the fenestration gap 410 between the members 108, 114 affirmatively engages the cleat clamping surfaces 302 with the recess clamping surfaces 402. For instance, the clamping surfaces 302, 402 slide over each other and anchor the mullion assembly 201 between the fenestration frame members 108, 114. Further movement of the mullion assembly 201 and corresponding movement along the clamping surfaces 302, 402 draws the fenestration frame members 108, 114 together, contracts the fenestration gap 410, and engages the fenestration frame members 108, 114 along the mullion assembly 201. In one example, the anchor cleats 202, 312 and the cleat recesses 204, 400 provide a camming type movement that draws the fenestration members 108, 114 together, and affirmatively engages the members and the mullion assembly 201.

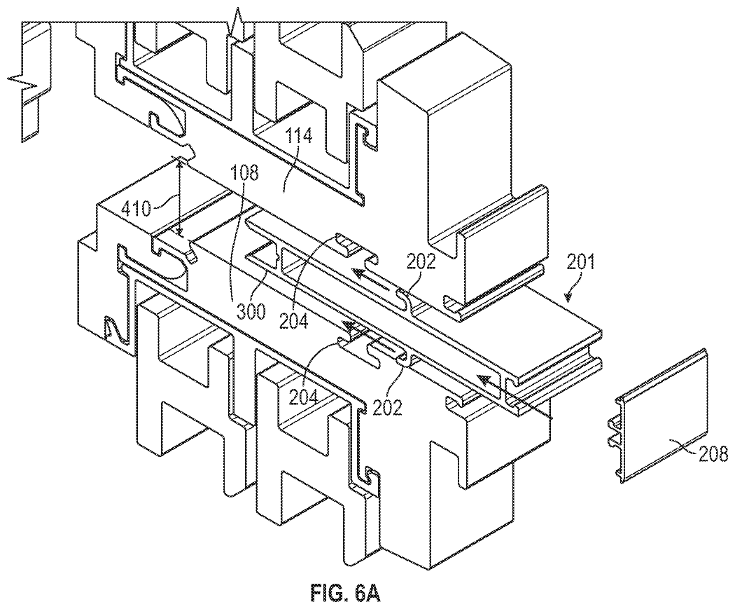

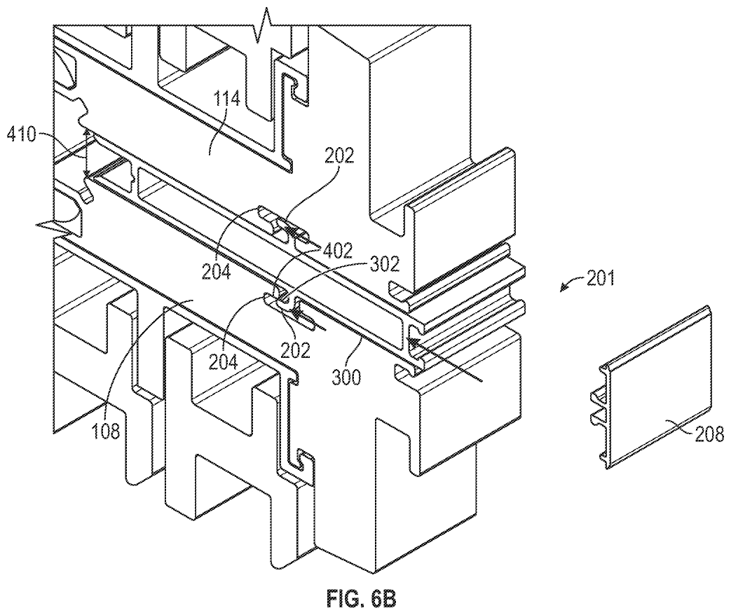

FIGS. 6A and 6B show the mullion assembly 201 in introduced and intermediate configurations, respectively. In one example, the mullion assembly 201 is transitioned through these configurations to the locked configuration shown in FIGS. 4A, B, and described above.

Referring first to FIG. 6A, the mullion pin 200 is shown in the introduced configuration. The mullion pin 200 is inserted into the fenestration gap 410 from either of the fenestration exterior or interior sides. In the present example, the mullion pin 200 is inserted to the fenestration gap 410 from exterior sides of the fenestration frame members 108, 114. In an example including the fenestration frame members 108, 114 positioned within a rough opening of a building, the mullion pin 200 is inserted into the fenestration gap 410 from the interior of the building or from the exterior and moved (as shown with the arrow) laterally toward the opposed side (e.g., exterior or interior) in contrast to vertically (e.g., along the long axes of the frame members). Conversely, vertical movement of the mullion pin (left or right in the orientation of FIG. 6A) is not needed, and accordingly introduction and movement may be conducted with the fenestration assemblies 102, 110 already positioned in the rough opening. Optionally, the mullion cover 208 is decoupled from the mullion pin 200 in the introduced configuration.

Lateral movement of the mullion pin 200 correspondingly moves the pin body 300 and anchor cleats 202 extending from the pin body 300 along the proximate surfaces of the fenestration frame members 108, 114. As shown with directional arrows, the anchor cleats 202 are moved toward the cleat recesses 204 of the respective first and second fenestration frame members 108, 114. As shown in FIG. 6B continued movement positions the anchor cleats 202 adjacent to the cleat recesses 204, and the anchor cleats 202 are delivered into the cleat recesses 204. Optionally, an installer may manipulate the fenestration assemblies 102, 110 having the members 108, 114, for instance by shifting the fenestration assemblies by hand, with a pry bar or the like to ensure the cleats drop into the recesses 204.

Referring now to FIG. 6B, the mullion pin 200 is shown in an intermediate configuration between the introduced configuration shown in FIG. 6A and the locked configuration shown in FIGS. 4A and 4B. As discussed, lateral movement of the mullion pin 200 (e.g., from interior toward exterior or exterior toward interior) aligns the anchor cleats 202 with the cleat recesses 204, and the cleats are positioned within the cleat recesses 204.

Continued lateral movement of the mullion pin 200 and the anchor cleats 202 affirmatively engages the cleats with the fenestration frame members 108, 114. As previously described, the anchor cleats 202 including clamping surfaces 302 (e.g., angled surfaces of the cleats) cooperatively engage with clamping surfaces 402 of the cleat recesses 204. The clamping surfaces 302, 402 move over each and the mullion assembly 201 draws the fenestration frame members 108, 114 toward each other, for instance based on the orientation of the clamping surfaces 302, 402 (e.g., cooperative angles, tapers, cammed surfaces or the like). The fenestration frame members 108, 114 are thereby locked together (e.g., in the locked configuration shown in FIGS. 4A and 4B). For instance, the cooperative coupling of the anchor cleats 202 and cleat recesses 204 and their associated clamping surfaces draws together (e.g., biases, clamps or the like) component fenestration assemblies. In one example, the drawing together of the fenestration frame members 108, 114 contracts the fenestration gap 410. For instance, as shown in FIGS. 6A and 6B the fenestration gap 410 is decreased as relative movement between the cleats and cleat recesses (and their associated clamping surfaces 302, 402) draws the frame members 108, 114 toward each other.

In another example, the locking bracket 206 is included with the mullion assembly 201 to enhance coupling between the mullion assembly 201 and the fenestration frame members 108, 114. With the mullion pin 200 in either of the locked configuration shown in FIGS. 4A, B or the intermediate configuration shown in FIG. 6B the locking bracket is readily coupled with the mullion pin 200. For instance, the locking bracket 206 is inserted from the other side of the fenestration frame members 108, 114; for instance from the interior if the mullion pin 200 was inserted from the exterior or from the exterior if the mullion pin 200 was inserted from the interior.

In one example, the bracket plug 318 of the locking bracket 206 is coupled with the pin socket 308 of the mullion pin 200 (e.g., the pin body 300). See FIG. 3. The anchor cleats 312 of the locking bracket 206 are seated within the cleat recesses 400 of the fenestration frame members 108, 114. Optionally, a fastener 314 is coupled between the locking bracket 206 and the mullion pin 200. In one example, the fastener 314 includes one or more screws, and the screw heads are accessed from the interior or exterior side of the fenestration frame members 108, 114. The fastener 314 is driven and accordingly moves the locking bracket 206 relative to the mullion pin 200. In the example shown in FIGS. 4A, B the locking bracket 206 and the mullion pin 200 are drawn toward each other. Their respective anchor cleats 312, 202 are corresponding drawn together. The clamping surfaces 302 of the cleats 312, 202 and the clamping surfaces 402 of the cleat recesses cooperate to bias the anchor cleats 312, 202 into a robust engagement with the fenestration frame members 108, 114 that further draws the frame members toward each other and into engagement along the mullion assembly 201. Additionally, the anchor cleats 312, 202, because of the transverse clamping surfaces 302 (opposed angles to each other) affirmatively clamp the intervening portions of the fenestration frame members 108, 114 therebetween.

The locking bracket 206 and mullion pin 200 are maintained in the locked configuration, optionally with the fastener 314 (in another example according to friction or interference fit), and the fenestration frame members 108, 114 are affirmatively coupled to the mullion assembly 201. After installation, the mullion cover 208 is coupled with the mullion assembly 201, for instance to conceal the remainder of the fenestration gap 410 between the fenestration frame members 108, 114. If adjustment, maintenance or removal of one or more of the fenestration assemblies 102, 110 (see FIG. 1) is specified the mullion assembly 201 is readily accessed from the interior or exterior face of the composite fenestration assembly 100 to decouple the assemblies 102, 110 or adjust the mullion assembly 201 (e.g., with manipulation of the fastener 314).

FIG. 7 is a cross sectional view of another example of a mullion assembly 701. In this example, the mullion assembly 701 couples together fenestration frame members 714, 716 with a mullion pin 700. As shown, the mullion pin includes a pin body 710 and anchor cleats 702 extending from the pin body 710. The anchor cleats 702 includes clamping surfaces 704. The fenestration frame members 714, 716 includes cleat recesses 718 complementary to the anchor cleats 702. Additionally, the cleat recesses 718 includes clamping surfaces 722 that interfit with the clamping surfaces 704 of the anchor cleats 702.

In the example shown in FIG. 7, the mullion pin 700 further includes a locking bracket 724. The locking bracket 724 includes anchor cleats 706. The fenestration frame members 714, 716 include cleat recesses 720 complementary to the anchor cleats 706. The cleat recesses 720 including clamping surfaces 722 complementary to clamping surfaces 708 of the anchor cleats 706. The locking bracket 724 is, in one example, integral to the mullion pin 700. In another example, the locking bracket 724 is a separate component from the mullion pin 700 and is coupled with the mullion pin 700, for instance during installation of the mullion assembly 701.

The mullion assembly 701 is shown in a locked configuration in FIG. 7. The anchor cleats 702, 706 are received in respective cleat recesses 718, 720. The anchor cleats 702, 706 (in a similar manner to the mullion assemblies described herein) clamp the first and second fenestration frame members 714, 716 together. For instance cooperative engagement of clamping surfaces 704, 707 of the anchor cleats 702, 706 and the clamping surfaces 722 of the cleat recesses 718, 720 biases the fenestration frame members 714, 716 together, contracts a fenestration gap between the members, and affirmatively engages the members 714, 716 along the along the mullion assembly 701 (e.g., the mullion pin 700).

In another example, the locking bracket 724 cooperates with the remainder of the mullion pin 700 to retain the mullion pin in the locked configuration. For instance, the anchor cleats 706 and complementary cleat recesses 720 (and clamping surfaces) cooperatively interfit (e.g., hook, fasten, anchor or the like) and the locking bracket 724 thereby maintains the anchor cleats 702 (and 706) in the locked configuration. Optionally, the locking bracket 724 compresses a portion of the mullion pin between the bracket 724 and the anchor cleats 706 thereby affirmatively retaining the anchor cleats in the locked configuration. In another example, the mullion pin 700 length between the locking bracket 724 and the anchor cleats 706 corresponds to the length between the cleat recesses 720, 718 to position the anchor cleats 706 within the cleat recesses 718 (e.g., without loading the mullion pin in compression or tension).

In a similar manner to the mullion assembly 201, the mullion assembly 701 including the mullion pin 700, is inserted between the fenestration frame members 714, 716, for example from an interior or exterior facing side of the fenestration assemblies. Accordingly, the fenestration assemblies are, in one example, positioned within a rough opening, and the mullion assembly 701, such as the mullion pin 700 is installed in the fenestration gap between the positioned assemblies (e.g., between the fenestration frame members 714, 716 of the assemblies). The mullion assembly 701 thereby permits coupling of the fenestration assemblies after initial positioning (while the assemblies are easier to separately manipulate). The mullion assembly 701 (like the assembly 201) is also optionally installed prior to positioning in the rough opening of the building, and accordingly permits the affirmative coupling of the fenestration assemblies to permit their aggregate transport and installation as a composite fenestration assembly if specified.

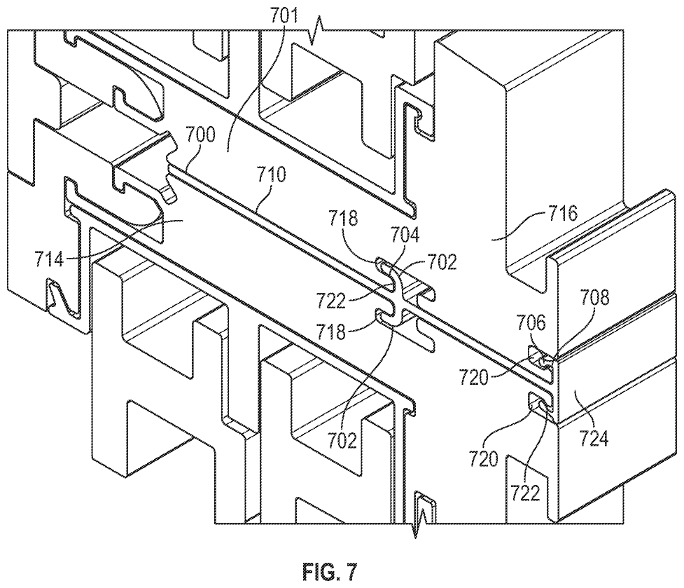

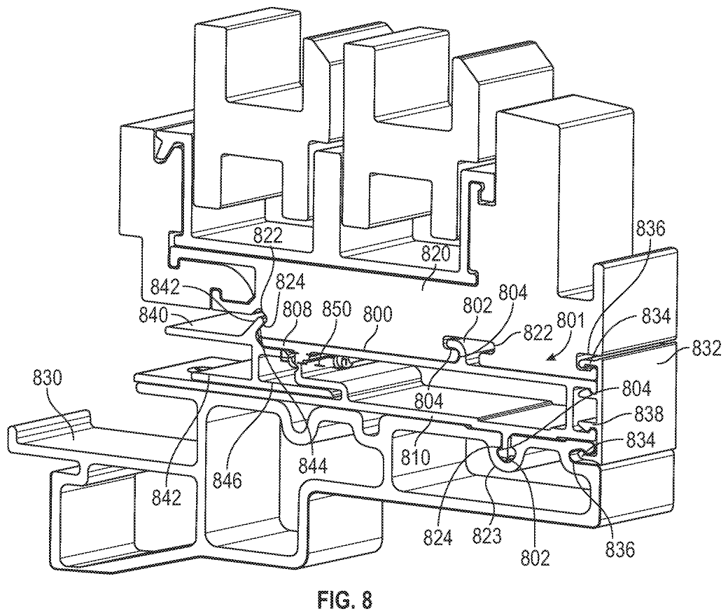

FIG. 8 is a cross sectional view showing another example of a mullion assembly 801 coupling together frame components. In this example, the mullion assembly 801 provides an interface between frame components having different profiles. For instance, the mullion pin 800 includes varied cleats 802, engagement features, or the like to interconnect the fenestration frame member 820 and the frame component 830 (such as a second frame member). The mullion assembly 801 thereby permits the interconnection of different types of fenestration frames (e.g., in the manner of an adapter) while also providing an affirmative and robust coupling therebetween.

The mullion assembly 801 includes a mullion pin 800 and a locking bracket 840. The pin 800 and bracket 840 include anchor cleats 802, 842 as in previous examples of mullion assemblies (e.g., 201, 701). In the present example, the mullion pin, locking bracket 840 and their respective anchor cleats 802, 842 have complementary profiles to the fenestration frame member 820 and frame component 830, as shown in FIG. 8. For example, the fenestration member 820 includes cleat recesses 822 while the frame component includes the cleat recess 823. Further, the mullion cover 832 includes its own anchor cleats 834 that are received within cleat recesses 836 of the frame member 820 and the frame component 830. The complementary arrangement of cleats and cleat recesses, profiles of the mullion pin 800 and the locking bracket 840 permit the interconnection of the disparate frame member 820 and frame component 830 while at the same time providing an affirmative coupling therebetween.

The mullion assembly 801, like other mullion assemblies described herein, facilitates the interconnection of the frame member 820 and the frame component 830. For instance, the mullion pin 800 is inserted into the fenestration gap between the frame member 820 and the frame component 830, as shown in FIG. 8. Insertion seats the anchor cleats 802 within the corresponding cleat recesses 822 of the frame member 820 and the frame component 830. The locking bracket 840 is inserted into the fenestration gap, and the anchor cleat 842 is seated within the corresponding cleat recess 822 of the fenestration frame member 820. Optionally a bracket plug 846 is coupled with a pin socket 808 of the mullion pin 800 slidably couple the bracket 840 and the pin 800.

A fastener 850 (shown in dashed lines) is optionally coupled between each of the locking bracket 840 and the mullion pin 800. Movement of the fastener 850 (e.g., such as rotation of a threaded fastener 840) moves the locking bracket 840 relative to the mullion pin 800. In this example, movement of the fastener 850 moves the bracket 840 and pin 800 closer to each other, for instance, the mullion pin 800 includes complementary threading. The anchor cleats 802, 842 having clamping surfaces 804, 844 cooperate with the opposed clamping surfaces of 824 of the cleat recesses 822. As the anchor cleats 802, 842 move over the cleat recesses 822 the fenestration frame member 820 and the frame component 830 are drawn together, and affirmatively engaged along the mullion assembly 801.

The fastener 850 retains the mullion assembly 801 in the position shown in FIG. 8, and accordingly retains the anchor cleats 802, 842 engaged with the fenestration frame member 820 and the frame component 830, and thereby affirmatively holds the member 820 and component 830 together.

In another example, the mullion assembly 801 includes the mullion cover 832 that extends over the remainder of the mullion assembly and provides a contoured surface between the frame member 820 and the frame component 830. As shown, the mullion cover 832 includes anchor cleats 834 received in corresponding cleat recesses 836 of the fenestration frame member 820 and the frame component 830. Additionally, the mullion cover 832 includes a cover fitting 838 that interfits with the mullion pin 800. The mullion cover 832 coupled with the mullion pin 800, the frame member 820 and the frame component 830 enhances retention of the coupling of the mullion assembly 801 with the member 820 and the component 830, and thereby assists in holding the anchor cleats of the mullion pin 800 within the respective cleat recesses.

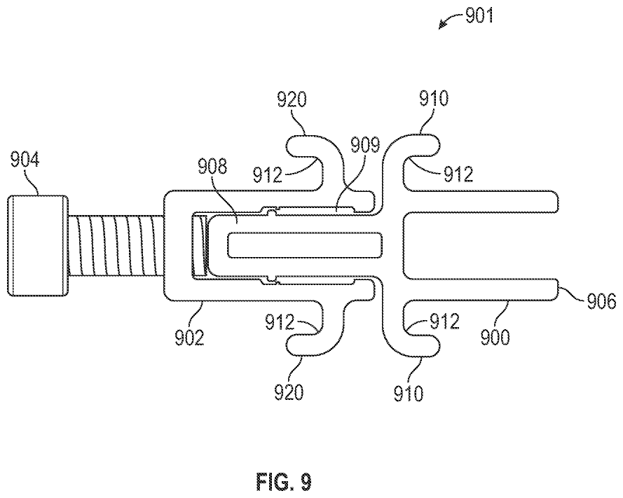

FIG. 9 is a cross sectional view of another example of a mullion assembly 901. The mullion assembly 901 includes a mullion pin 900 and a locking bracket 902. As described herein, one or more of the mullion pin 900 or the locking bracket 902 extend into and out of the page. For instance, the mullion pin 900 and locking bracket 902 are optionally elongate members that are positioned along frame members of fenestration assemblies.

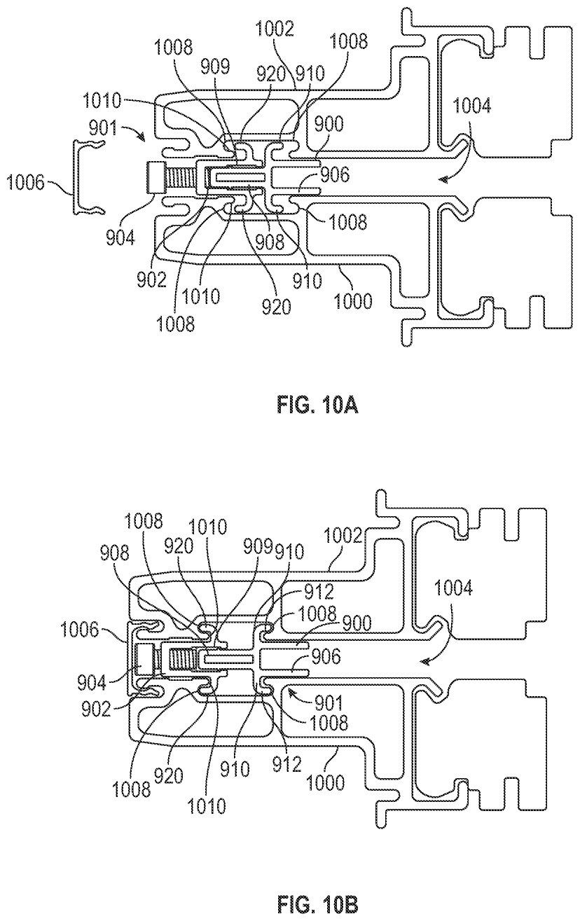

As further shown in FIG. 9, the mullion pin 900 includes a pin body 906 having one or more anchor cleats 910 and associated clamping surfaces 912. The mullion pin 900 further includes a jack 908 movably received within a jack socket 909 of the locking bracket 902. As described herein, the mullion assembly 901 is expanded or contracted with movement of the jack 908 relative to the locking bracket 902. This relative movement positions the anchor cleats 910 (as well as the cleats 920) affirmatively within corresponding cleat recesses of the fenestration frame members (see FIGS. 10A, B and 11).

The locking bracket 902 is movably coupled with the mullion pin 900 in this example. As previously discussed, and shown in FIG. 9 the locking bracket 902 includes a jack socket 909 that receives the jack 908 of the mullion pin 900. The locking bracket further includes anchor cleats 920 having their own clamping surfaces 912. The cleats 920, 910 are directed in opposing directions, and as shown herein couple with complementary cleat recesses. The jack 908 drives the anchor cleats 910, 920 apart and the cleats are thereby affirmatively and cooperatively engaged with the cleat recesses of the fenestration assemblies to lock the fenestration assemblies to the mullion assembly 901.

A fastener 904 is coupled with the locking bracket 902. In one example, the fastener 904 includes a graduated interface, such as threading, and the locking bracket 902 has a complementary graduated interface. Movement of the fastener, such as rotation, longitudinally moves the fastener 904, in the manner of a jack driver or actuator, relative to the jack socket 909 and accordingly drives the jack 908. This movement drives the anchor cleats 910, 920 apart and correspondingly affirmatively engages the anchor cleats with the complementary clamping surfaces of the cleat recesses. Conversely, reversed movement of the fastener 904 backs out the fastener and relaxes the engagement of the anchor cleats 910, 920, for instance to permit adjustment, removal of the mullion assembly 901 or the like.

FIGS. 10A and 10B illustrate an example installation of the mullion assembly 901 with first and second fenestration assemblies 1000, 1002. FIG. 10A shows an introduced configuration and FIG. 10B shows a locked configuration of the mullion assembly 901. As shown in FIG. 10A the mullion assembly 901 is positioned within a fenestration gap 1004. For instance, the mullion assembly 901 is preassembled and is inserted into the fenestration gap between the fenestration assemblies 1000, 1002 from the exterior or interior sides of the assemblies. The mullion assembly 901 slid along the opposed surfaces of the fenestration assemblies 1000, 1002 until the anchor cleats 910, 920 are seated within openings of the assemblies 1000, 1002 having the cleat recesses 1008. The mullion assembly 901 (like other mullion assemblies described herein) permits assembly of a mull joint with the component fenestration assemblies 1000, 1002 already positioned within a rough opening of a building (e.g., a framed opening ready to receive the fenestration assemblies). Optionally, during installation the mullion pin 900 and the locking bracket 902 are decoupled and, as described with other embodiments, may be inserted into the fenestration gap 1004 between fenestration assemblies 1000, 1002, for instance from the exterior and interior sides of the fenestration assemblies. Reception of the anchor cleats 910, 920 of the mullion pin 900 and the locking bracket 902 within the openings having the cleat recesses 1008 aligns the jack 908 with the jack socket 909 and an installer may use a tool, such as a screwdriver or the like (pressing on the pin body 906) to drive the jack 908 into the jack socket 909 and assemble the mullion assembly 901.

Referring again to FIG. 10A the fastener 904 is shown recessed from the jack socket 909. The jack 908 is accordingly received within the length of the jack socket 909. Optionally, the jack 908 includes a snug tolerance (e.g., width) relative to the jack socket 909 to provide a snug engagement that maintains the jack 908 in the position shown until acted upon by the fastener 904. The anchor cleats 910, 920 are correspondingly positioned proximate to each other (contracted) and thereby readily received in the openings of the fenestration assemblies 1000, 1002 having the cleat recesses 1008.

Referring now to FIG. 10B the mullion assembly 901 is shown in a locked configuration. The fastener 904 is moved relative to the locking bracket 902 and extends into the jack socket 909. The jack 908 and the remainder of the mullion pin 900 are accordingly driven relative to the locking bracket 902. The movement of the mullion pin 900 relative to the locking bracket 902 moves the respective anchor cleats 910, 920 toward the associated cleat recesses 1008 and seats the cleats therein. In this example, the movement expands the mullion assembly 901. In other examples, the movement contracts the mullion assembly, for instance where the anchor cleats and cleat recesses opposed orientations (e.g., are directed toward, taper toward, angle toward each other or the like). Additional movement of the fastener 904 further drives the mullion pin 900 and thereby cooperatively and affirmatively expands the anchor cleats 910, 920 from each other, and engages the anchor cleats 910, 920 and their associated clamping surfaces 912 (see FIG. 9) with the clamping surfaces 1008 of the cleat recesses 1008. The fenestration gap 1004 is optionally contracted with the interfitting of the clamping surfaces 912, 1008 (e.g., according to taper, angle of the surfaces or the like). The anchor cleats 910, 920 in the shown locked configuration thereby affirmatively couple the fenestration assemblies 1000, 1002 together. In an example, the clamping surfaces 912, 1008 include an angled orientation (e.g., tapered, curved, hooked, angled relative to the interior to exterior axis of the pin body 900 or the like). Accordingly, cooperative engagement of the clamping surfaces 912, 1008 locks the fenestration assemblies 1000, 1002 to the mullion assembly 901. Optionally, the angled orientation of the clamping surfaces 912, 1008 biases the fenestration assemblies 1000, 1002 toward the mullion assembly 901 and affirmatively engages the fenestration assemblies along the mullion assembly, for instance along the pin body 906, locking bracket 902 or the like.

In another example, the mullion assembly 901 includes a mullion cover 1006. The mullion cover 1006 is decoupled from the fenestration assemblies 1000, 1002 while the remainder of the mullion assembly 901 is installed and adjusted (e.g., to lock the fenestration assemblies together). After coupling of the fenestration assemblies 1000, 1002 the mullion cover 1006 is coupled between the fenestration assemblies, for instance with complementary kerfs provided along the assemblies. The mullion cover 1006, as shown in FIG. 10B bridges between the fenestration assemblies 1000, 1002 and conceals the fenestration gap 1004 and the remainder of the mullion assembly 901.

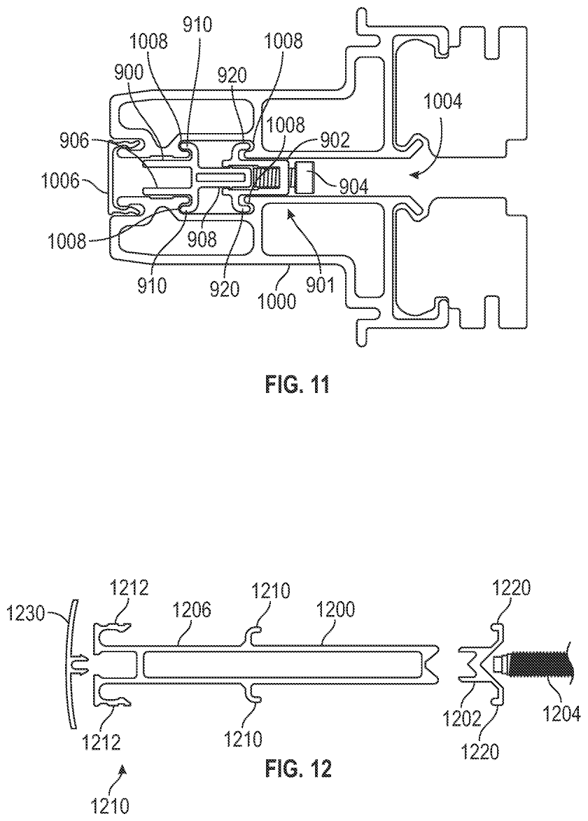

FIG. 11 shows a reversed orientation of the mullion assembly 901. In this example, the mullion assembly 901 includes the mullion pin 900 proximate to the (exterior) left sides of the fenestration assemblies while the locking bracket 902 is proximate to the (interior) right sides of the fenestration assemblies including more proximate to the right side than the mullion pin 900. In this example, the fastener 904 is directed to the (interior) right and is accordingly accessible from the right sides of the fenestration assemblies to conduct transition of the mullion assembly 901 from the introduced to the locked configurations.

FIG. 12 is an exploded view of another example of a mullion assembly 1201. The mullion assembly 1201 is similar in some regards to other mullion assemblies described herein. For example, the mullion assembly 1200 includes a mullion pin 1200 and a locking bracket 1202. The mullion pin 1200 and the locking bracket 1202 include associated anchor cleats 1210, 1212, 1220, and the anchor cleats interfit with complementary cleat recesses of fenestration assemblies to affirmatively couple the fenestration assemblies together.

Referring again to FIG. 12, the mullion pin 1200 includes a pin body 1206. The mullion pin 1200 includes anchor cleats 1210, 1212. The anchor cleats 1210 are positioned along the pin body 1206 and the anchor cleats 1212 are, in this example, positioned proximate an end of the pin body 1206. A mullion cover 1230 is also shown in FIG. 12 proximate to the pin body 1206 and the anchor cleats 1212.

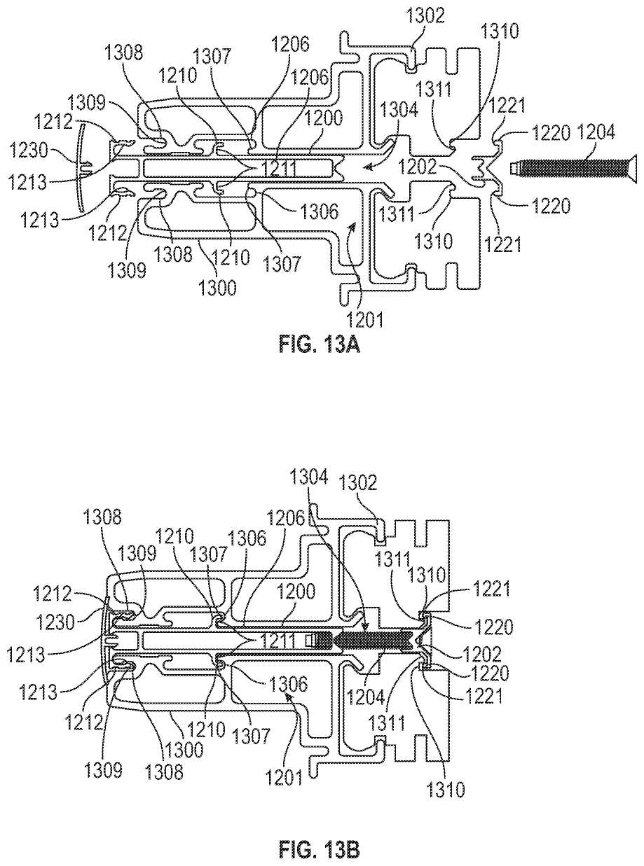

The locking bracket 1202 includes the anchor cleats 1220. In this example, the anchor cleats 1220 are directed toward the mullion pin 1200 while the anchor cleats 1210, 1212 of the mullion pin 1200 are directed toward the locking bracket 1202. Conversely, in the example shown in FIG. 9 the anchor 910, 920 are directed away from each other. Referring again to FIG. 12, a fastener 1204 is shown proximate to the locking bracket 1202. In an example, the fastener 1204 includes a graduated fitting, such as threading. The locking bracket 1202 includes a hole or similar to permit passage of the fastener 1204. Optionally, the contour of the hole includes a complementary graduated fitting (e.g., threading). The mullion pin 1200, such as a portion of the pin body 1206 proximate to the locking bracket 1202 includes complementary graduated fitting, such as threading, to movably couple with the fastener 1204. As shown in FIGS. 13A, B the locking bracket 1202 and mullion pin 1200 are moved relative to each other (toward each other in this example) with the fastener 1204 to correspondingly move the anchor cleats 1210, 1212 and 1220, relative to associated cleat recesses and affirmatively engage with the fenestration assemblies to lock the assemblies to the mullion assembly 1201 and each other.

FIGS. 13A and 13B illustrate another example installation with the mullion assembly 1201 and first and second fenestration assemblies 1300, 1302. FIG. 13A shows an introduced configuration and FIG. 13B shows a locked configuration of the mullion assembly 1201. As shown in FIG. 13A the mullion assembly 1201 is positioned within a fenestration gap 1304. For instance, the mullion assembly 1201 is inserted into the fenestration gap between the fenestration assemblies 1300, 1302 from the exterior or interior sides of the assemblies. The mullion pin 1200 is slid along the opposed surfaces of the fenestration assemblies 1300, 1302 until the anchor cleats 1210, 1212 are seated within associated cleat recesses 1306, 1308.

The locking bracket 1202 is inserted from an opposed side of the fenestration assemblies 1300, 1302 (e.g., from the interior or exterior opposed to the insertion of the mullion pin 1200). The anchor cleats 1220 of the locking bracket 1202 are positioned within cleat recesses 1310 of the fenestration assemblies 1300, 1302. The fastener 1204 is inserted through the locking bracket 1202, and similarly inserted into the fenestration gap 1304. Actuation of the fastener 1204, such as rotation, couples the fastener 1204 with the mullion pin 1200 (e.g., with threading). The locking bracket 1202 and the mullion pin 1200 are coupled, in this example, indirectly with the fastener 1204.

The mullion assembly 1201 (like other mullion assemblies described herein) permits assembly of a mull joint with the component fenestration assemblies 1300, 1302 already positioned within a rough opening of a building (e.g., a framed opening ready to receive the fenestration assemblies).

Referring now to FIG. 13B the mullion assembly 1201 is shown in a locked configuration. The fastener 1204 is coupled between the locking bracket 1202 and the mullion pin 1200. The fastener 1204 is further actuated (e.g., rotated, driven or the like) and draws the mullion pin 1200 toward the locking bracket 1202. The movement of the mullion pin 1200 relative to the locking bracket 1202 moves the respective anchor cleats 1210, 1210, 1220 toward the associated cleat recesses 1306, 1308, 1310 and seats the cleats therein. In this example, the movement contracts the mullion assembly 1201. In other examples, the movement expands the mullion assembly, for instance where the anchor cleats and cleat recesses have opposed orientations (e.g., are directed away, taper away, angle away from each other or the like). Additional movement of the fastener 1204 further draws the mullion pin 1200 and thereby cooperatively and affirmatively contracts the anchor cleats 1220 and 1210, 1212 toward each other, and engages the anchor cleats 1210, 1212, 1220 and their associated clamping surfaces 1211, 1213, 1221 (see FIG. 13A) with the clamping surfaces 1307, 1309, 1311 of the cleat recesses 1306, 1308, 1310.

The fenestration gap 1304 is optionally contracted with the interfitting of the clamping surfaces (e.g., according to taper, angle of the surfaces or the like). The anchor cleats 1210, 1212, 1220 in the shown locked configuration thereby affirmatively couple the fenestration assemblies 1300, 1302 together. In an example, the clamping surfaces 1211, 1213, 1221, 1307, 1309, 1311 include an angled orientation (e.g., tapered, curved, hooked, angled relative to the interior to exterior axis of the pin body 1200 or the like). Accordingly, cooperative engagement of the clamping surfaces 912, 1008 locks the fenestration assemblies 1000, 1002 to the mullion assembly 901. Optionally, the angled orientation of the clamping surfaces biases the fenestration assemblies 1200, 1302 toward the mullion assembly 1201 and affirmatively engages the fenestration assemblies along the mullion assembly, for instance along the pin body 1200, locking bracket 1202 or the like.

In another example, the mullion assembly 1201 includes a mullion cover 1230. After coupling of the fenestration assemblies 1300, 1302 the mullion cover 1230 is coupled between the fenestration assemblies, for instance with coupling of a fitting of the cover with a corresponding recess of the mullion pin 1200. The mullion cover 1230, as shown in FIG. 13B bridges between the fenestration assemblies 1300, 1302 and conceals the fenestration gap 1304 and the remainder of the mullion assembly 1201.

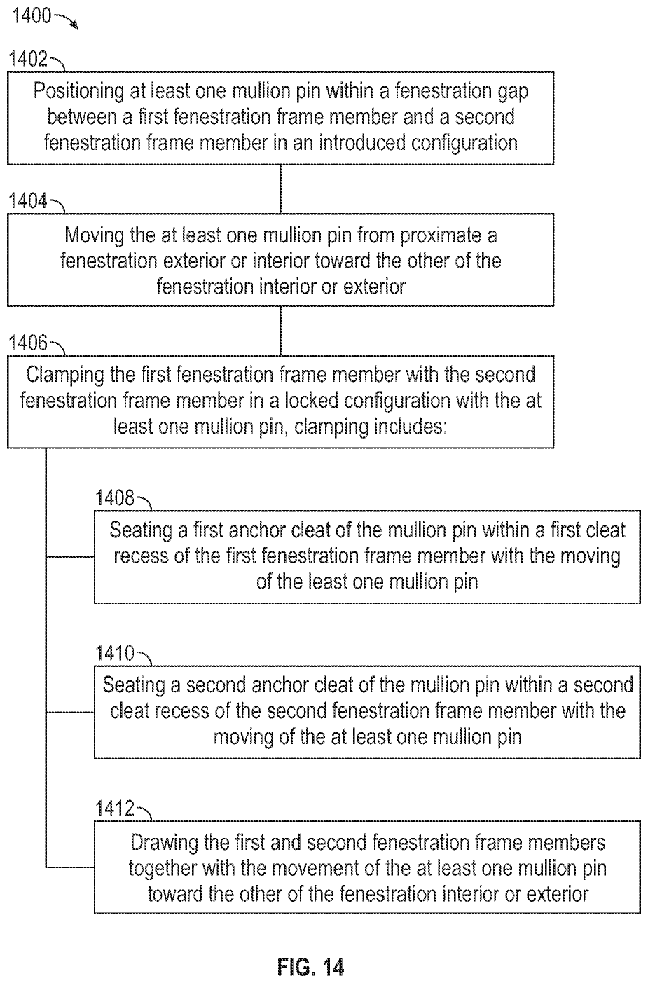

FIG. 14 shows one example of a method 1400 for mulling fenestration assemblies, such as the fenestration assemblies shown herein. In describing the method 1400, reference is made to one or more components, features, functions, steps or the like previously described herein. Where convenient, reference is made to the components, features, functions, steps or the like with reference numerals. Reference numerals provided are exemplary and are not exclusive. For instance, components, features, functions, steps or the like described in the method 1400 include, but are not limited to, corresponding numbered elements provided herein, other corresponding features described herein (both numbered and unnumbered) as well as their equivalents.

The method 1400 includes at 1402 positioning at least one mullion pin within a fenestration gap between a first fenestration frame member and a second fenestration frame member in an introduced configuration. In one example, positioning the at least one mullion pin within the fenestration gap includes inserting the mullion pin from one of the fenestration exterior or the fenestration interior. Optionally, inserting of the mullion pin into the fenestration gap is conducted with the component fenestration assemblies having the first and second fenestration frame members already positioned within a rough opening of a building. At 1404, the method includes moving the at least one mullion pin from proximate a fenestration exterior or interior toward the other of the fenestration interior or exterior. Moving the at least one mullion pin includes in one example actuating a fastener coupled between a locking bracket and the mullion pin.

The method 1400 includes clamping the first fenestration frame member with the second fenestration frame member in a locked configuration with the at least one mullion pin at 1406. Clamping includes at 1408 seating a first anchor cleat of the mullion pin within a first cleat recess of the first fenestration frame member with the moving of the at least one mullion pin. Clamping further includes seating a second anchor cleat of the mullion pin within a second cleat recess of the second fenestration frame member with the moving of the at least one mullion pin at 1410. Optionally, at 1412 clamping includes drawing the first and second fenestration frame members together with the movement of the at least one mullion pin toward the other of the fenestration interior or exterior. Drawing the first and second fenestration members together includes pulling the mullion pin toward the locking bracket. In another example, drawing the first and second fenestration members together includes driving the mullion pin away from the locking bracket.

Several options for the method 1400 follow. In one example, drawing the first and second fenestration frame members together includes engaging clamping surfaces of the first and second cleats with complementary clamping surfaces of the first and second cleat recesses, respectively. In another example, engaging clamping surfaces includes moving the clamping surfaces relative to the complementary clamping surfaces to drive the first and second fenestration frame members together. In still another example, clamping the first and second fenestration frame members in the locked configuration includes securing the first and second cleats in a position to retain drawn together first and second fenestration frame members with a locking bracket. Securing the first and second cleats includes optionally coupling the locking bracket with the mullion pin and tensioning the mullion pin. In another option, securing the first and second cleats includes coupling the locking bracket with the mullion pin and compressing the mullion pin. Optionally, securing the first and second cleats includes coupling the locking bracket with the mullion pin and constraining movement of the mullion pin toward the introduced configuration.

In another example, one of the mullion pin or the locking bracket includes a jack and the other of the locking bracket or the mullion pin includes a jack recess that slidably receives the jack. In this example, moving the at least one mullion pin includes moving the jack within the jack recess of the locking bracket.

In an additional example, clamping the first and second fenestration frame members in the locked configuration includes seating third and fourth anchor cleats of the locking bracket with third and fourth cleat recesses of the respective first and second fenestration frame members. Clamping in the locked configuration optionally includes drawing the first and second fenestration frame members together with grasping of the first fenestration frame member between the first and third anchor cleats and grasping of the second fenestration frame member between the second and fourth anchor cleats.

### Various Notes and Aspects

Aspect 1 can include subject matter such as a mullion assembly comprising: a first fenestration frame member of a first fenestration assembly, the first fenestration frame member having a first cleat recess; a second fenestration frame member of a second fenestration assembly, the second fenestration frame member having a second cleat recess; a fenestration gap between the first and second fenestration frame members, the fenestration gap extending from a fenestration interior to a fenestration exterior of the first and second fenestration frame members; at least one mullion pin within the fenestration gap, the at least one mullion pin includes: a pin body movably coupled between the first and second fenestration frame members; and first and second anchor cleats extending from the pin body; and wherein the at least one mullion pin is movable from an introduced configuration to a locked configuration: in the introduced configuration the pin body is positioned in the fenestration gap proximate to one of the fenestration exterior or interior; and in the locked configuration the pin body is moved toward the other of the fenestration interior or exterior, the first and second anchor cleats are seated in the first and second cleat recesses, and the first and second anchor cleats are configured to clamp the first and second fenestration frame members together.

Aspect 2 can include, or can optionally be combined with the subject matter of Aspect 1, to optionally include wherein the first and second fenestration frame members are positioned within a rough opening of a building in the introduced and locked configurations.

Aspect 3 can include, or can optionally be combined with the subject matter of one or any combination of Aspects 1 or 2 to optionally include the first fenestration assembly and the second fenestration assembly.

Aspect 4 can include, or can optionally be combined with the subject matter of one or any combination of Aspects 1-3 to optionally include wherein the first and second anchor cleats each include a clamping surface; the clamping surface of the first anchor cleat, in the locked configuration, is configured to couple with the first fenestration frame member in the first cleat recess and bias the first fenestration frame member toward the second fenestration frame member; and the clamping surface of the second anchor cleat, in the locked configuration, is configured to couple with the second fenestration frame member in the second cleat recess and bias the second fenestration frame member toward the first fenestration frame member.

Aspect 5 can include, or can optionally be combined with the subject matter of one or any combination of Aspects 1-4 to optionally include wherein the first and second anchor cleats each include a clamping surface, and the clamping surfaces engage with the first and second fenestration frame members in the locked configuration to clamp the first and second fenestration frame members together and contract the fenestration gap.

Aspect 6 can include, or can optionally be combined with the subject matter of Aspects 1-5 to optionally include wherein the first and second anchor cleats each include a clamping surface, and the first and second cleat recesses include complementary clamping surfaces; and in the locked configuration moving of the pin body toward the other of the fenestration interior or exterior is configured to clamp the first and second fenestration frame members together.

Aspect 7 can include, or can optionally be combined with the subject matter of Aspects 1-6 to optionally include wherein in the locked configuration the first anchor cleat clamping surface and the complementary clamping surface of the first cleat recess engage, the second anchor cleat clamping surface and the complementary clamping surface of the second cleat recess engage; and the moving of the pin body and engaging of the clamping surfaces is configured to drive the first and second fenestration frame members toward each other.

Aspect 8 can include, or can optionally be combined with the subject matter of Aspects 1-7 to optionally include a locking bracket within the fenestration gap, the locking bracket includes: a bracket body coupled between the first and second fenestration frame members; and third and fourth anchor cleats extending from the bracket body.

Aspect 9 can include, or can optionally be combined with the subject matter of Aspects 1-8 to optionally include wherein the first fenestration frame member includes a third cleat recess and the second fenestration frame member includes a fourth cleat recess; and in the locked configuration the locking bracket is configured: to move the pin body toward the other of the fenestration interior or exterior; and seat the first and second anchor cleats in the first and second cleat recesses and seat the third and fourth anchor cleats in the third and fourth cleat recesses.

Aspect 10 can include, or can optionally be combined with the subject matter of Aspects 1-9 to optionally include wherein the locking bracket and the mullion pin are coupled with a fastener, and in the locked configuration the fastener tensions the mullion pin to move the mullion pin and seat the first and second anchor cleats in the first and second cleat recesses and seat the third and fourth anchor cleats in the third and fourth cleat recesses.

Aspect 11 can include, or can optionally be combined with the subject matter of Aspects 1-10 to optionally include wherein the locking bracket and the mullion pin are coupled with a fastener, and in the locked configuration the fastener compresses the mullion pin to move the mullion pin and seat the first and second anchor cleats in the first and second cleat recesses and seat the third and fourth anchor cleats in the third and fourth cleat recesses.

Aspect 12 can include, or can optionally be combined with the subject matter of Aspects 1-11 to optionally include wherein in the locked configuration the first and third anchor cleats capture a portion of the first fenestration frame member therebetween, and the second and fourth anchor cleats capture a portion of the second fenestration frame member therebetween.

Aspect 13 can include, or can optionally be combined with the subject matter of Aspects 1-12 to optionally include wherein the locking bracket includes a jack recess; the mullion pin includes a jack received within the jack recess; and wherein the jack is configured to transition the at least one mullion pin between the introduced and locked configurations.

Aspect 14 can include, or can optionally be combined with the subject matter of Aspects 1-13 to optionally include wherein the locking bracket is coupled with the mullion pin with a fastener, and the locking bracket is spaced from the mullion pin.

Aspect 15 can include, or can optionally be combined with the subject matter of Aspects 1-14 to optionally include wherein at least the fastener and the mullion pin have a threaded coupling.

Aspect 16 can include, or can optionally be combined with the subject matter of Aspects 1-15 to optionally include wherein in the locked configuration the mullion pin is in one of tension or compression.

Aspect 17 can include, or can optionally be combined with the subject matter of Aspects 1-16 to optionally include a mullion assembly comprising: at least one mullion pin configured to clamp proximate fenestration frame members together, the at least one mullion pin includes: a pin body configured for movable coupling between the proximate fenestration frame members; and first and second anchor cleats extending from the pin body; a locking bracket coupled with the at least one mullion pin; and wherein the at least one mullion pin is movable from an introduced configuration to a locked configuration: in the locked configuration the first and second anchor cleats are configured to clamp the fenestration frame members together, and the locking bracket secures the first and second anchor cleats in a position to maintain clamping of the fenestration frame members.

Aspect 18 can include, or can optionally be combined with the subject matter of Aspects 1-17 to optionally include wherein the at least one mullion pin is movably coupled with the locking bracket, and movement of the at least one mullion pin relative to the locking bracket moves the mullion pin from the introduced configuration to the locked configuration.

Aspect 19 can include, or can optionally be combined with the subject matter of Aspects 1-18 to optionally include a fastener coupled between the at least one mullion pin and the locking bracket, and the fastener is configured to move the at least one mullion pin relative to the locking bracket.

Aspect 20 can include, or can optionally be combined with the subject matter of Aspects 1-19 to optionally include wherein the locking bracket includes at least third and fourth anchor cleats, and movement of the mullion pin from the introduced configuration to the locked configuration is configured to: drive the first anchor cleat of the mullion pin toward the third anchor cleat of the locking bracket and capture a portion of one proximate fenestration frame member therebetween; drive the second anchor cleat of the mullion pin toward the fourth cleat of the locking bracket and capture a port of another proximate fenestration frame member therebetween.

Aspect 21 can include, or can optionally be combined with the subject matter of Aspects 1-20 to optionally include wherein the first, second, third and fourth anchor cleats include clamping surfaces, the clamping surfaces of the first and third anchor cleats are transverse to each other, and the clamping surfaces of the second and fourth anchor cleats are transverse to each other.

Aspect 22 can include, or can optionally be combined with the subject matter of Aspects 1-21 to optionally include the proximate fenestration frame members, and the proximate fenestration frame members include: a first fenestration frame member having a first cleat recess; and a second fenestration frame member having a second cleat recess.

Aspect 23 can include, or can optionally be combined with the subject matter of Aspects 1-22 to optionally include wherein in the locked configuration the first anchor clear is seated within the first cleat recess, and the second anchor clear is seated within the second cleat recess.

Aspect 24 can include, or can optionally be combined with the subject matter of Aspects 1-23 to optionally include wherein in the introduced configuration the pin body is position in a fenestration gap between the first and second fenestration frame members; and in the locked configuration the pin body is moved across the first and second fenestration frame members to seat the first and second anchor cleats within the respective first and second cleat recesses.

Aspect 25 can include, or can optionally be combined with the subject matter of Aspects 1-24 to optionally include wherein the locking bracket includes a bracket plug, the mullion pin includes a pin socket, and in at least the locked configuration the bracket plug is received in the pin socket.

Aspect 26 can include, or can optionally be combined with the subject matter of Aspects 1-25 to optionally include a mullion cover coupled with at least one of the mullion pin or the locking bracket.

Aspect 27 can include, or can optionally be combined with the subject matter of Aspects 1-26 to optionally include wherein the locking bracket is integral to the mullion pin, and the locking bracket is coupled with the remainder of the mullion pin at one or more of a proximal or distal end portion of the mullion pin.

Aspect 28 can include, or can optionally be combined with the subject matter of Aspects 1-27 to optionally include wherein the locking bracket and the mullion pin are coupled with a fastener, and in the locked configuration the fastener compresses or tensions the mullion pin to move the mullion pin and seat the first and second anchor cleats in the first and second cleat recesses.

Aspect 29 can include, or can optionally be combined with the subject matter of Aspects 1-28 to optionally include wherein the locking bracket includes a jack recess; the mullion pin includes a jack received within the jack recess; and wherein the jack is configured to transition the at least one mullion pin between the introduced and locked configurations.

Aspect 30 can include, or can optionally be combined with the subject matter of Aspects 1-29 to optionally include wherein the locking bracket is coupled with the mullion pin with a fastener, and the locking bracket is spaced from the mullion pin.

Aspect 31 can include, or can optionally be combined with the subject matter of Aspects 1-30 to optionally include wherein in the locked configuration the mullion pin is in one of tension or compression.

Aspect 32 can include, or can optionally be combined with the subject matter of Aspects 1-31 to optionally include a method for mulling fenestration assemblies comprising: positioning at least one mullion pin within a fenestration gap between a first fenestration frame member and a second fenestration frame member in an introduced configuration; moving the at least one mullion pin from proximate a fenestration exterior or interior toward the other of the fenestration interior or exterior; clamping the first fenestration frame member with the second fenestration frame member in a locked configuration with the at least one mullion pin, clamping includes: seating a first anchor cleat of the mullion pin within a first cleat recess of the first fenestration frame member with the moving of the at least one mullion pin; seating a second anchor cleat of the mullion pin within a second cleat recess of the second fenestration frame member with the moving of the at least one mullion pin; and drawing the first and second fenestration frame members together with the movement of the at least one mullion pin toward the other of the fenestration interior or exterior.

Aspect 33 can include, or can optionally be combined with the subject matter of Aspects 1-32 to optionally include wherein drawing the first and second fenestration frame members together includes engaging clamping surfaces of the first and second cleats with complementary clamping surfaces of the first and second cleat recesses, respectively.

Aspect 34 can include, or can optionally be combined with the subject matter of Aspects 1-33 to optionally include wherein engaging clamping surfaces includes moving the clamping surfaces relative to the complementary clamping surfaces to drive the first and second fenestration frame members together.

Aspect 35 can include, or can optionally be combined with the subject matter of Aspects 1-34 to optionally include wherein clamping the first and second fenestration frame members in the locked configuration includes securing the first and second cleats in a position to retain drawing of the first and second fenestration frame members together with a locking bracket.

Aspect 36 can include, or can optionally be combined with the subject matter of Aspects 1-35 to optionally include wherein securing the first and second cleats includes coupling the locking bracket with the mullion pin and tensioning the mullion pin.

Aspect 37 can include, or can optionally be combined with the subject matter of Aspects 1-36 to optionally include wherein securing the first and second cleats includes coupling the locking bracket with the mullion pin and compressing the mullion pin.

Aspect 38 can include, or can optionally be combined with the subject matter of Aspects 1-37 to optionally include wherein one of the mullion pin or the locking bracket includes a jack and the other of the locking bracket or the mullion pin includes a jack recess that slidably receives the jack; and wherein moving the at least one mullion pin includes moving the jack within the jack recess of the locking bracket.

Aspect 39 can include, or can optionally be combined with the subject matter of Aspects 1-38 to optionally include wherein securing the first and second cleats includes coupling the locking bracket with the mullion pin and constraining movement of the mullion pin toward the introduced configuration.

Aspect 40 can include, or can optionally be combined with the subject matter of Aspects 1-39 to optionally include wherein clamping the first and second fenestration frame members in the locked configuration includes: seating third and fourth anchor cleats of the locking bracket with third and fourth cleat recesses of the respective first and second fenestration frame members; and drawing the first and second fenestration frame members together with grasping of the first fenestration frame member between the first and third anchor cleats and grasping of the second fenestration frame member between the second and fourth anchor cleats.

Aspect 41 can include, or can optionally be combined with the subject matter of Aspects 1-40 to optionally include wherein drawing the first and second fenestration members together includes pulling the mullion pin toward the locking bracket.

Aspect 42 can include, or can optionally be combined with the subject matter of Aspects 1-41 to optionally include wherein drawing the first and second fenestration members together includes driving the mullion pin away from the locking bracket.

Aspect 43 can include, or can optionally be combined with the subject matter of Aspects 1-42 to optionally include wherein moving the at least one mullion pin includes actuating a fastener coupled between a locking bracket and the mullion pin.

Aspect 44 can include, or can optionally be combined with the subject matter of Aspects 1-43 to optionally include wherein positioning the at least one mullion pin within the fenestration gap includes inserting the mullion pin from one of the fenestration exterior or the fenestration interior.

Each of these non-limiting aspects can stand on its own, or can be combined in various permutations or combinations with one or more of the other aspects.

The above description includes references to the accompanying drawings, which form a part of the detailed description. The drawings show, by way of illustration, specific embodiments in which the invention can be practiced. These embodiments are also referred to herein as “aspects” or “examples.” Such aspects or example can include elements in addition to those shown or described. However, the present inventors also contemplate aspects or examples in which only those elements shown or described are provided. Moreover, the present inventors also contemplate aspects or examples using any combination or permutation of those elements shown or described (or one or more features thereof), either with respect to a particular aspects or examples (or one or more features thereof), or with respect to other Aspects (or one or more features thereof) shown or described herein.

In the event of inconsistent usages between this document and any documents so incorporated by reference, the usage in this document controls.

In this document, the terms “a” or “an” are used, as is common in patent documents, to include one or more than one, independent of any other instances or usages of “at least one” or “one or more.” In this document, the term “or” is used to refer to a nonexclusive or, such that “A or B” includes “A but not B,” “B but not A,” and “A and B,” unless otherwise indicated. In this document, the terms “including” and “in which” are used as the plain-English equivalents of the respective terms “comprising” and “wherein.” Also, in the following claims, the terms “including” and “comprising” are open-ended, that is, a system, device, article, composition, formulation, or process that includes elements in addition to those listed after such a term in a claim are still deemed to fall within the scope of that claim. Moreover, in the following claims, the terms “first,” “second,” and “third,” etc. are used merely as labels, and are not intended to impose numerical requirements on their objects.

Geometric terms, such as “parallel”, “perpendicular”, “round”, or “square”, are not intended to require absolute mathematical precision, unless the context indicates otherwise. Instead, such geometric terms allow for variations due to manufacturing or equivalent functions. For example, if an element is described as “round” or “generally round,” a component that is not precisely circular (e.g., one that is slightly oblong or is a many-sided polygon) is still encompassed by this description.

The above description is intended to be illustrative, and not restrictive. For example, the above-described aspects or examples (or one or more aspects thereof) may be used in combination with each other. Other embodiments can be used, such as by one of ordinary skill in the art upon reviewing the above description. The Abstract is provided to comply with 37 C.F.R. § 1.72(b), to allow the reader to quickly ascertain the nature of the technical disclosure. It is submitted with the understanding that it will not be used to interpret or limit the scope or meaning of the claims. Also, in the above Detailed Description, various features may be grouped together to streamline the disclosure. This should not be interpreted as intending that an unclaimed disclosed feature is essential to any claim. Rather, inventive subject matter may lie in less than all features of a particular disclosed embodiment. Thus, the following claims are hereby incorporated into the Detailed Description as aspects, examples or embodiments, with each claim standing on its own as a separate embodiment, and it is contemplated that such embodiments can be combined with each other in various combinations or permutations. The scope of the invention should be determined with reference to the appended claims, along with the full scope of equivalents to which such claims are entitled.

1. A mullion assembly comprising:
a first fenestration frame member of a first fenestration assembly, the first fenestration frame member having a first cleat recess;
a second fenestration frame member of a second fenestration assembly, the second fenestration frame member having a second cleat recess;
a fenestration gap between the first and second fenestration frame members, the fenestration gap extending from a fenestration interior to a fenestration exterior of the first and second fenestration frame members;
at least one mullion pin within the fenestration gap, the at least one mullion pin includes:
a pin body movably coupled between the first and second fenestration frame members; and
first and second anchor cleats extending from the pin body; and
wherein the at least one mullion pin is movable from an introduced configuration to a locked configuration:
in the introduced configuration the pin body is positioned in the fenestration gap proximate to one of the fenestration exterior or interior; and
in the locked configuration the pin body is moved toward the other of the fenestration interior or exterior, the first and second anchor cleats are seated in the first and second cleat recesses, and the first and second anchor cleats are configured to clamp the first and second fenestration frame members together.

2. The mullion assembly of claim 1, wherein the first and second fenestration frame members are positioned within a rough opening of a building in the introduced and locked configurations.

3. The mullion assembly of claim 1 comprising the first fenestration assembly and the second fenestration assembly.

4. The mullion assembly of claim 1, wherein the first and second anchor cleats each include a clamping surface;
the clamping surface of the first anchor cleat, in the locked configuration, is configured to couple with the first fenestration frame member in the first cleat recess and bias the first fenestration frame member toward the second fenestration frame member; and
the clamping surface of the second anchor cleat, in the locked configuration, is configured to couple with the second fenestration frame member in the second cleat recess and bias the second fenestration frame member toward the first fenestration frame member.

5. The mullion assembly of claim 1, wherein the first and second anchor cleats each include a clamping surface, and the clamping surfaces engage with the first and second fenestration frame members in the locked configuration to clamp the first and second fenestration frame members together and contract the fenestration gap.

6. The mullion assembly of claim 1, wherein the first and second anchor cleats each include a clamping surface, and the first and second cleat recesses include complementary clamping surfaces; and
in the locked configuration moving of the pin body toward the other of the fenestration interior or exterior is configured to clamp the first and second fenestration frame members together.

7. The mullion assembly of claim 6, wherein in the locked configuration the first anchor cleat clamping surface and the complementary clamping surface of the first cleat recess engage, the second anchor cleat clamping surface and the complementary clamping surface of the second cleat recess engage; and
the moving of the pin body and engaging of the clamping surfaces is configured to drive the first and second fenestration frame members toward each other.

8. The mullion assembly of claim 1, comprising a locking bracket within the fenestration gap, the locking bracket includes:
a bracket body coupled between the first and second fenestration frame members; and
third and fourth anchor cleats extending from the bracket body.

9. The mullion assembly of claim 8, wherein the first fenestration frame member includes a third cleat recess and the second fenestration frame member includes a fourth cleat recess; and
in the locked configuration the locking bracket is configured:
to move the pin body toward the other of the fenestration interior or exterior; and
seat the first and second anchor cleats in the first and second cleat recesses and seat the third and fourth anchor cleats in the third and fourth cleat recesses.

10. The mullion assembly of claim 9, wherein the locking bracket and the mullion pin are coupled with a fastener, and in the locked configuration the fastener tensions the mullion pin to move the mullion pin and seat the first and second anchor cleats in the first and second cleat recesses and seat the third and fourth anchor cleats in the third and fourth cleat recesses.

11. The mullion assembly of claim 9, wherein the locking bracket and the mullion pin are coupled with a fastener, and in the locked configuration the fastener compresses the mullion pin to move the mullion pin and seat the first and second anchor cleats in the first and second cleat recesses and seat the third and fourth anchor cleats in the third and fourth cleat recesses.

12. The mullion assembly of claim 9, wherein in the locked configuration the first and third anchor cleats capture a portion of the first fenestration frame member therebetween, and the second and fourth anchor cleats capture a portion of the second fenestration frame member therebetween.

13. The mullion assembly of claim 8, wherein the locking bracket includes a jack recess;
the mullion pin includes a jack received within the jack recess; and
wherein the jack is configured to transition the at least one mullion pin between the introduced and locked configurations.

14. The mullion assembly of claim 8, wherein the locking bracket is coupled with the mullion pin with a fastener, and the locking bracket is spaced from the mullion pin.

15. The mullion assembly of claim 14, wherein at least the fastener and the mullion pin have a threaded coupling.

16. The mullion assembly of claim 1, wherein in the locked configuration the mullion pin is in one of tension or compression.

17. A mullion assembly comprising:
at least one mullion pin configured to clamp proximate fenestration frame members together, the at least one mullion pin includes:
a pin body configured for movable coupling between the proximate fenestration frame members; and
first and second anchor cleats extending from the pin body;
a locking bracket coupled with the at least one mullion pin; and
wherein the at least one mullion pin is movable from an introduced configuration to a locked configuration:
in the locked configuration the first and second anchor cleats are configured to clamp the fenestration frame members together, and the locking bracket secures the first and second anchor cleats in a position to maintain clamping of the fenestration frame members.

18. The mullion assembly of claim 17, wherein the at least one mullion pin is movably coupled with the locking bracket, and movement of the at least one mullion pin relative to the locking bracket moves the mullion pin from the introduced configuration to the locked configuration.

19. The mullion assembly of claim 18 comprising a fastener coupled between the at least one mullion pin and the locking bracket, and the fastener is configured to move the at least one mullion pin relative to the locking bracket.

20. The mullion assembly of claim 18, wherein the locking bracket includes at least third and fourth anchor cleats, and movement of the mullion pin from the introduced configuration to the locked configuration is configured to:
drive the first anchor cleat of the mullion pin toward the third anchor cleat of the locking bracket and capture a portion of one proximate fenestration frame member therebetween;
drive the second anchor cleat of the mullion pin toward the fourth cleat of the locking bracket and capture a port of another proximate fenestration frame member therebetween.

21. The mullion assembly of claim 20, wherein the first, second, third and fourth anchor cleats include clamping surfaces, the clamping surfaces of the first and third anchor cleats are transverse to each other, and the clamping surfaces of the second and fourth anchor cleats are transverse to each other.

22. The mullion assembly of claim 17 comprising the proximate fenestration frame members, and the proximate fenestration frame members include:
a first fenestration frame member having a first cleat recess; and
a second fenestration frame member having a second cleat recess.

23. The mullion assembly of claim 22, wherein in the locked configuration the first anchor clear is seated within the first cleat recess, and the second anchor clear is seated within the second cleat recess.

24. The mullion assembly of claim 22, wherein in the introduced configuration the pin body is position in a fenestration gap between the first and second fenestration frame members; and
in the locked configuration the pin body is moved across the first and second fenestration frame members to seat the first and second anchor cleats within the respective first and second cleat recesses.

25. The mullion assembly of claim 17, wherein the locking bracket includes a bracket plug, the mullion pin includes a pin socket, and in at least the locked configuration the bracket plug is received in the pin socket.

26. The mullion assembly of claim 17 comprising a mullion cover coupled with at least one of the mullion pin or the locking bracket.

27. The mullion assembly of claim 17, wherein the locking bracket is integral to the mullion pin, and the locking bracket is coupled with the remainder of the mullion pin at one or more of a proximal or distal end portion of the mullion pin.

28. The mullion assembly of claim 17, wherein the locking bracket and the mullion pin are coupled with a fastener, and in the locked configuration the fastener compresses or tensions the mullion pin to move the mullion pin and seat the first and second anchor cleats in the first and second cleat recesses.

29. The mullion assembly of claim 17, wherein the locking bracket includes a jack recess;
the mullion pin includes a jack received within the jack recess; and
wherein the jack is configured to transition the at least one mullion pin between the introduced and locked configurations.

30. The mullion assembly of claim 17, wherein the locking bracket is coupled with the mullion pin with a fastener, and the locking bracket is spaced from the mullion pin.

31. The mullion assembly of claim 17, wherein in the locked configuration the mullion pin is in one of tension or compression.

32. A method for mulling fenestration assemblies comprising:
positioning at least one mullion pin within a fenestration gap between a first fenestration frame member and a second fenestration frame member in an introduced configuration;
moving the at least one mullion pin from proximate a fenestration exterior or interior toward the other of the fenestration interior or exterior;
clamping the first fenestration frame member with the second fenestration frame member in a locked configuration with the at least one mullion pin, clamping includes:
seating a first anchor cleat of the mullion pin within a first cleat recess of the first fenestration frame member with the moving of the at least one mullion pin;
seating a second anchor cleat of the mullion pin within a second cleat recess of the second fenestration frame member with the moving of the at least one mullion pin; and
drawing the first and second fenestration frame members together with the movement of the at least one mullion pin toward the other of the fenestration interior or exterior.

33. The method of claim 32, wherein drawing the first and second fenestration frame members together includes engaging clamping surfaces of the first and second cleats with complementary clamping surfaces of the first and second cleat recesses, respectively.

34. The method of claim 33, wherein engaging clamping surfaces includes moving the clamping surfaces relative to the complementary clamping surfaces to drive the first and second fenestration frame members together.

35. The method of claim 32, wherein clamping the first and second fenestration frame members in the locked configuration includes securing the first and second cleats in a position to retain drawing of the first and second fenestration frame members together with a locking bracket.

36. The method of claim 35, wherein securing the first and second cleats includes coupling the locking bracket with the mullion pin and tensioning the mullion pin.

37. The method of claim 35, wherein securing the first and second cleats includes coupling the locking bracket with the mullion pin and compressing the mullion pin.

38. The method of claim 35, wherein one of the mullion pin or the locking bracket includes a jack and the other of the locking bracket or the mullion pin includes a jack recess that slidably receives the jack; and
wherein moving the at least one mullion pin includes moving the jack within the jack recess of the locking bracket.

39. The method of claim 35, wherein securing the first and second cleats includes coupling the locking bracket with the mullion pin and constraining movement of the mullion pin toward the introduced configuration.

40. The method of claim 35, wherein clamping the first and second fenestration frame members in the locked configuration includes:
seating third and fourth anchor cleats of the locking bracket with third and fourth cleat recesses of the respective first and second fenestration frame members; and
drawing the first and second fenestration frame members together with grasping of the first fenestration frame member between the first and third anchor cleats and grasping of the second fenestration frame member between the second and fourth anchor cleats.

41. The method of claim 35, wherein drawing the first and second fenestration members together includes pulling the mullion pin toward the locking bracket.

42. The method of claim 35, wherein drawing the first and second fenestration members together includes driving the mullion pin away from the locking bracket.

43. The method of claim 32, wherein moving the at least one mullion pin includes actuating a fastener coupled between a locking bracket and the mullion pin.

44. The method of claim 32, wherein positioning the at least one mullion pin within the fenestration gap includes inserting the mullion pin from one of the fenestration exterior or the fenestration interior.
